(19) United States
(12) Patent Application Publication
(10) Pub. No.: US 2014/0176330 A1
(43) Pub. Date: Jun. 26, 2014

(54) Inexpensive safety alerting devices for munitions and a detector for same

(71) Applicant: Sten R. Gerfast, Mendota Heights, MN (US)

(72) Inventor: Sten R. Gerfast, Mendota Heights, MN (US)

(21) Appl. No.: 13/694,705

(22) Filed: Dec. 26, 2012

(51) Int. Cl. G08B 13/24

(52) U.S. Cl. CPC G08B 13/2451
USPC 340/572.1

(57) ABSTRACT

This is an inexpensive detector to prevent mass murders by guns, and illegal use of fire arms. Inexpensive antenna bands affixed to ammunition casings or to the barrel or other part of a fire arm activates a detector/sender which is generating specific radio frequencies, and which is also a beam-forming generator.

The beam of a specific radio frequency is reflected back to the detector, mounted on a building, or carried by a law enforcer. When the reflected signal from the antenna bands reaches the detector, an output signal is produced in the detector, which is used to alert safety personnel or electronic alarms, that a gun is nearby. It also has several safety features in case the antenna bands are tampered with, or removed.

### BRIEF DESCRIPTION

This is an inexpensive detector to prevent mass murders by guns, and illegal use of fire arms.

The inexpensive lifesaving safety devices described in this invention are radio frequency responding bands on guns and radio frequency responding bands on ammunition detectable by a radio frequency detector/sender on a law enforcement fire arm. The detector can also be attached to buildings or homes. When the detector senses such bands, and ascertains its presence, the detector produces an output signal which can used to alert safety personnel or electronic alarms. The bands, which are inexpensive to produce and assemble, are substantially permanently affixed to the munitions. Munitions, in its many variants, includes: guns, pistols, shotguns, rifles (non-automatic and automatic); ammunition, bullets, cartridges, etc.

### BACKGROUND AND RELATED ART

Munitions described in the previous paragraph are used to provide safety for polis, security for our elected officials, Marshals onboard an aircraft and for many other safety providers.

The U.S. Constitution also allows a U.S. citizen to bear fire arms of the above listed varieties. But fire arms have also been used to inflict multiple death's and injuries when many people are gathered at a schools, theaters, sport events or shopping malls.

It has been proposed to post armed guards in all our schools and the other mentioned gathering places. It has been described as an effective deterrent for the mass-murders that has recently occurred, but it would also be at a substantial expense, probably not affordable, by schools and other gathering places.

The present invention would be an affordable deterrent

The modifications to the munitions, as described the invention's Claims can be implemented without a prohibitive cost.

The rightful legal use of firearms would not be affected. When a person would use the modified fire arms it would be transparent to the user that it has been modified, when the firearm is used for hunting, shooting practice or other legal uses. The exception would be if a person intended to use the fire arms to inflict death and mass murders and carried the modified munitions into an area a short distance from a schools or other buildings entrance, where a Detector would be placed.

The Detector, which is also described in the Claims, would sense modified munitions at the entrance and produce an output signal which can used to alert safety personnel or electronic alarms.

A battery powered, hand held, detector is used for similar detection of a fire arm or detection of ammunition for a fire arm, which is nearby.

The detector, which is similar to a key-fob opening your car door is inexpensively manufactured.

### PRESENT INVENTION

The present invention is inexpensive antenna bands affixed to ammunition casings or to a part of a fire arm, and a detector which is generating specific radio frequencies, that is also a beam-forming generator. When the beam of a specific radio frequency is reflected back to the detector from the antenna bands, placed either on a casing of a bullet, or on a fire arm itself, an output signal is produced in the detector, which is used to alert safety personnel or electronic alarms that a gun or ammunition is nearby.

The antenna band is also inexpensively manufactured.

The detector can have an amplification factor determined by the desired range of detection.

To deter tampering with the modified gun, or removal of the antenna band, the gun is also modified with an opening under the band to send explosion gases down to the trigger finger. A cautionary note on the gun and on the ammunition would state: Removal of the band will cause severe burns on your trigger finger . . . or explosion of the gun barrel. To further deter tampering, or if the antenna band would be removed, a link in the trigger mechanism would fall out, preventing the force from the trigger to be transmitted.

The above summary is not intended to describe each disclosed embodiment or every implementation of the present invention. Figures and the detailed description described herein, is not intended to limit other embodiments.

### BRIEF DESCRIPTION OF THE DRAWING

FIG. 1. is showing a commonly used ammunition casing and bullet with attached safety band, and the modification of the gun chamber to accommodate the safety band on the casing.

FIG. 2 is a partial view of a detector mounted on a building, with beam function.

FIG. 3 is a drawing of one type of antenna that is the core of the safety band.

FIG. 4 is a drawing of another type of foldable antenna that can be used to create a capacitive function with stacked sheets, that is the core of the safety band.

FIG. 5 is a drawing of a linear type of antenna to be rolled up; showing interconnections.

FIG. 6 is a drawing of a hand gun with an attached detector/sender.

### DETAILED DESCRIPTION OF THE DRAWING

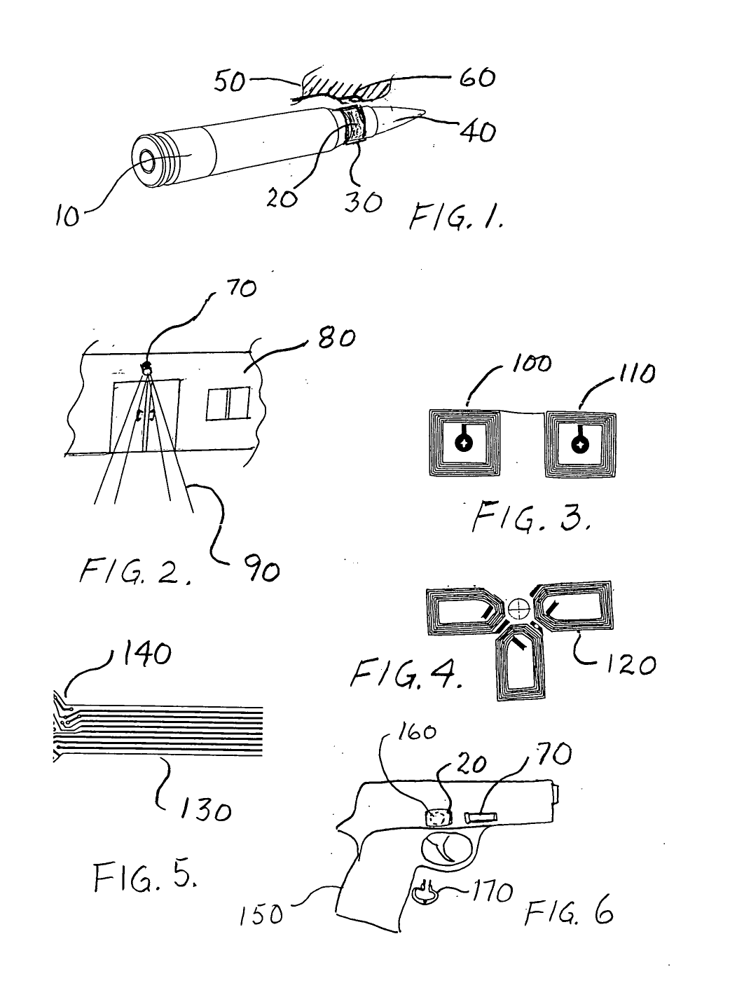

FIG. 1. is showing a commonly used ammunition casing 10 and bullet 40 with attached safety band 20 and encapsulating compound 30 around the band 20. A small cross section of the guns chamber 50 is also showing the modification 60 that is necessary to accommodate the band 20.

FIG. 2 is a detector 70 mounted on a building 80 shown in partial view, with beam function 90 protecting the entrance to the building 80. the detector 70 can be operated on AC or battery and can be removed to be used as a hand carried detector 70.

FIG. 3 is a drawing of one type of an antenna having two parts 100 and 110 that are shown in a complimentary winding configuration, that is the core of the safety band.

FIG. 4 is a drawing of a three part antenna 120, which is a foldable antenna that also can be used to create a capacitive function with stacked sheets. This antenna when rolled up is also the core of the safety band.

FIG. 5 is a drawing of a linear type of antenna 130; to be rolled up; showing interconnections 140.

FIG. 6 is a drawing of a hand gun 150 with an attached detector/sender 70 and a safety band 20. To deter tampering, if the safety band 20 is removed an opening 160 is exposed, which will carry explosion gases towards the trigger finger. An cautionary note would state: “Removal of this safety band will severely burn your trigger finger or cause explosion of the gun barrel.” To further prevent tampering an important trigger part 170 will drop out, which is very difficult to re-install.

1. Inexpensive safety alerting bands for munitions, and a detector, comprising:
an attached band substantially permanently affixed on ammunition, the band containing an inductive coil antenna suitable to respond to specific radio frequency generated and sent towards the band by a detector/sender which is tuned to sense such bands, and when ascertaining the presence of said bands, the detector produces an output signal which is used to alert safety personnel or electronic alarms.

2. Inexpensive safety alerting bands for fire arms, and a detector, comprising:
an attached band substantially permanently affixed to a fire arm said band containing a plurality of inductive coil antenna's and a capacitive function, wherein a coil antenna and capacitive function produces an L-C circuit, suitable to respond to specific radio frequency generated and sent towards the band by a detector which is tuned to sense such bands, and when ascertaining the presence of said bands, the detector produces an output signal which is used to alert safety personnel or electronic alarms.

3. Inexpensive safety alerting bands for ammunition and fire arms, and a detector, comprising:
an attached band substantially permanently affixed to a bullet casing fitting a fire arm,
and an attached band substantially permanently affixed to a fire arm, said band containing an inductive coil antenna and a capacitive function, wherein coil antenna and capacitive function produces an L-C circuit, and the circuit is a resonance circuit, suitable to respond to specific radio frequency generated and sent towards the band by a detector which is tuned to sense such bands, with the detector containing strong amplification, to be able to ascertain the presence of said bands, at which time the detector produces an output signal which is used to alert safety personnel or electronic alarms.

4. Safety alerting band according to claim 1 wherein the inductive coil antenna is a plurality of printed ink lines on a plurality of thin film sheets rolled into a narrow band.

5. Safety alerting band according to claim 1 wherein the inductive coil antenna is a plurality of lines on a thin film rolled into a narrow band, affixed around the ammunition in a decreased diameter ammunition area

6. Safety alerting band according to claim 2 wherein the inductive coil antenna is a plurality of printed ink lines or copper lines on a thin film rolled into a narrow band affixed around the fire arm's barrel or other appropriate area on the fire arm.

7. Safety alerting band according to claim 2 wherein the inductive coil antenna is a plurality of lines on a plurality of thin sheets stacked to achieve capacitive functions and the stacked sheets rolled into a narrow band, affixed on the fire arm's barrel or an appropriate area of the fire arm, or on the ammunition casing.

8. Safety alerting band according to claim 6 wherein the narrow band is encapsulated with a compound which is non-absorbing of radio frequencies; with said compounds including thermo-set plastics, ceramics, plastics and epoxies.

9. Safety alerting band according to claim 1 wherein the detector which is generating specific radio frequencies is also a beam-forming generator and receiver mounted on the entrance of a building.

10. Safety alerting band according to claim 3 wherein the detector which is generating specific radio frequencies is also a beam-forming generator and receiver mounted on a portable fire arm, or similar hand held device.

11. Safety alerting band according to claim 2 wherein tampering with the band on the fire arm causes an opening to be exposed, which carries explosive gases towards the trigger finger when the gun is fired.

12. Safety alerting band according to claim 2 wherein tampering and removal of the band causes an important trigger part to drop out, which is very difficult to re-install.

13. Safety alerting band according to claim 2 wherein the inductive coil antenna as assembled in layers creates a capacitive function and produces an L-C circuit, which can be resonant.

14. Safety alerting band according to claim 2 wherein the range of the detector is further extended by additional amplification.

15. Safety alerting band according to claim 1 Wherein the band is affixed in such a manner that machine type tools would be required to remove the band.

16. Safety alerting band according to claim 2 wherein the detector is powered with a small battery inside the fire arm.

17. Safety alerting band according to claim 3 wherein bullet casing's magazines are required, by mandate, to be made out of material transparent to radio frequencies.
